(19) United States
(12) Patent Application Publication
(10) Pub. No.: US 2007/0051716 A1
(43) Pub. Date: Mar. 8, 2007

(54) Process for manufacturing packaged cored welding electrode

(75) Inventors: Dennis K. Hartman, North Ridgeville, OH (US); Herbert H. Matthews III, Willoughby, OH (US); James C. Nicklas, Eastlake, OH (US); Vaidyanath B. Rajan, Mentor, OH (US)

Correspondence Address: FAY SHARPE / LINCOLN, 1100 SUPERIOR AVENUE, SEVENTH FLOOR, CLEVELAND, OH, 44114, US

(73) Assignee: Lincoln Global, Inc.

(21) Appl. No.: 11/220,165

(22) Filed: Sep. 6, 2005

(51) Int. Cl. B23K 35/02

(52) U.S. Cl. 219/145.22

(57) ABSTRACT

A manufacturing process is disclosed for manufacturing and packaging cored welding electrode. The process comprises providing core fill material, providing a strip of sheath material, bending the strip into a U or V shape, adding the fill material into a channel of the bent strip, joining the outer edges of the strip to provide a cored electrode with the fill material enclosed within the sheath material, providing a generally rectangular container, and installing the cored electrode into the container.

### FIELD OF THE INVENTION

The present invention relates generally to arc welding technology, and more particularly to processes for the manufacture and packaging of flux cored welding electrodes.

### INCORPORATION BY REFERENCE

Cored welding electrodes and methods of manufacturing the same are described in the following United States patents, the contents of which are hereby incorporated by reference as background information: Weed U.S. Pat. No. 1,525,840; Lincoln U.S. Pat. No. 1,722,929; Bernard U.S. Pat. No. 2,785,285; Sjoman U.S. Pat. No. 2,944,142; Woods U.S. Pat. No. 3,534,390; Gonzalez U.S. Pat. No. 3,947,655; Gonzalez U.S. Pat. No. 4,286,293; Puschner U.S. Pat. No. 4,305,197; Amata U.S. Pat. No. 4,551,610; Holmgren U.S. Pat. No. 4,629,110; Chai U.S. Pat. No. 4,717,536; Munz U.S. Pat. No. 4,723,061; Marshall U.S. Pat. No. 4,800,131; Crockett U.S. Pat. No. 4,833,296; Chai U.S. Pat. No. 5,003,155; Crockett U.S. Pat. No. 5,015,823; Chai U.S. Pat. No. 5,055,655; Chai U.S. Pat. No. 5,118,919; Kotecki U.S. Pat.No. 5,120,931; Gordish U.S. Pat. No. 5,233,160; Crockett U.S. Pat. No. 5,365,036; Kulikowski U.S. Pat. No. 5,369,244; Araki U.S. Pat. No. 5,821,500; Kramer U.S. Pat. No. 5,973,291; Inoue U.S. Pat. No. 6,079,243; Pan U.S. Pat. No. 6,103,997; Kotecki U.S. Pat. No. 6,339,209; Stava U.S. Pat. No. 6,365,864; Hughes U.S. Pat. No. 6,674,047; Kelly U.S. Pat. No. 6,750,430; Matsuguchi US 2005/0044687 A1; and Kim US 2005/0077277 A1. Containers and packaging methods for storage of solid welding electrode wire and related technology is generally set forth in the following United States patents and published applications, the contents of which are hereby incorporated by reference as background information: Kawasaki U.S. Pat. No. 4,869,367; Cooper U.S. Pat. No. 5,277,314; Gelmetti U.S. Pat. No. 5,494,160; Chung U.S. Pat. No. 5,746,380; Cooper U.S. Pat. No. 5,819,934; Cooper U.S. Pat. No. 6,019,303; Cooper U.S. Pat. No. 6,260,781; Cipriani U.S. Pat. No. 6,481,575; Blain U.S. Pat. No. 6,547,176; Barton U.S. Pat. No. 6,564,943; Weissbrod U.S. Pat. No. 6,637,593; Land U.S. Pat. No. 6,648,141; Matsuguchi U.S. Pat. No. 6,827,217; Gelmetti US 2003/0052030 A1; Weissbrod US 2004/0000498 A1; Barton US 2004/0206652 A1; Barton US 2004/0211851 A1; Hsu US 2005/0023392 A1; and Hsu US 2005/0023401.

### BACKGROUND OF THE INVENTION

Arc welding is a process of joining metals through deposition of molten metal to a workpiece using an arc between a consumable welding electrode and the workpiece. The welding electrode is directed by a wire feeder toward the welding operation in the form of a continuous wire fed through a welding torch cable from a wire supply, and an arc is generated at the torch between the electrode and the workpiece for melting and depositing electrode material to a weld pool on the workpiece in a controlled fashion. Many arc welding processes, such as gas metal arc welding (GMAW), employ an external inert shielding gas such as Argon or a non-inert external shielding gas such as CO₂ around the welding arc to inhibit oxidation or nitridation of the molten metal. Other arc welding processes provide a protective shield of vapor or slag to cover the arc and molten weld pool. The molten electrode material may be transferred to the workpiece by several mechanisms or processes, such as short-circuit welding, spray arc welding, and pulse welding.

Cored welding electrodes are consumable welding devices with a tubular core or interior region surrounded by an outer sheath, where the core may include alloying elements, deoxidizing and denitriding agents, and fluxing elements, as well as elements that increase weld metal toughness and strength, impart corrosion resistance and stabilize the welding arc. Cored electrodes are typically constructed beginning with a flat metal strip that is initially formed first into a “U” shape, for example, as shown in Bernard U.S. Pat. No. 2,785,285, Sjoman U.S. Pat. No. 2,944,142 and Woods U.S. Pat. No. 3,534,390. Alloying elements, flux and/or other core fill materials are then deposited into the “U” and the strip is closed into a tubular configuration by a series of forming rolls. One class of such cored welding electrodes is called metal-cored electrode, which is a cored electrode having alloying elements in the core fill material. Metal-cored welding processes (GMAW-C) typically depend on shielding entirely from external gas sources and very little shielding properties are provided by the fill material. In contrast, flux-cored arc welding processes (FCAW-G) include flux within the electrode core to produce an extensive slag cover during welding, which in combination with the externally applied gas shielding, protects and shapes the welding bead. In self-shielded arc welding processes (FCAW-S), gas generated by decomposition of the gas forming ingredients in the core in combination with the slag produced from the flux material provides protection for the weld bead.

Metal or flux-cored arc welding can be a semi-automatic or an automatic process, the latter being particularly advantageous in certain robotic welding applications. These processes employ cored electrodes to provide either increased welding speeds and/or higher deposition rates without excessive current draw, wherein GMAW-C and FCAW electrodes are used for welding large sections and materials of great thickness and lengths, especially in the flat or horizontal positions. Metal-cored (GMAW-C) electrodes referred to as Metalshield® electrodes employ an external shielding gas consisting of mixtures of argon (Ar) and carbon dioxide (CO₂) or oxygen (O₂) in conjunction with the added alloying elements in the fill to obtain the desired weld metal properties. Gas shielded Flux-cored (FCAW-G) electrodes referred to as Outershield® electrodes employ a mixture of Ar and CO₂ or 100% CO₂ in conjunction with slag from the flux in the fill to produce good welds from a stable arc with very little spatter. Self-shielded Flux-cored (FCAW-S) referred to as Innershield® electrodes rely on decomposition and vaporization of the fill material to form gas and slag for protection of the weld metal. Various types of cored electrodes are designed for specific gas-shielded welding applications involving high-speed, single-pass sheet metal welding, general purpose welding, structural fabrication, pipe welding, etc. wherein the constituent materials used in the core and the electrode diameters used may be tailored for a given situation.

Automated metal or flux-cored welding applications involving robotic welding systems require a large continuous supply of welding electrode to minimize system downtime for changeover from an exhausted supply to a new supply. It is therefore desirable in such GMAW-C or FCAW applications to use packages, such as drums, for containing and dispensing large quantities of welding electrode wire. While welding wire drums produce effective containers for welding wire with regard to maintaining the welding wire in coiled configuration therein, the cylindrical configuration is not well suited for transporting and/or storing the container itself. For example, when multiple cylindrical storage drums are to be moved or stored together, such as on a shipping skid or pallet, adjacent wire drums engage one another only along a very small vertical line of contact, whereby any forces therebetween are focused along the small contact patch. This problem can lead to container damage and/or damage to the electrode coils inside the drum, even for minimal contact between adjacent drums or other objects. Moreover, many conventional cylindrical drum containers are fabricated from materials that are not easily recyclable. Accordingly, there is a need for improved methods for manufacturing packaged cored welding electrodes to reduce the amount of non-recyclable container material while providing protection for the cored electrodes against physical deformation and humidity during transportation and storage prior to introduction to a welding process.

### SUMMARY OF INVENTION

A summary of one or more aspects of the invention is now presented in order to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The present invention relates to cored welding electrodes or wires and methods for manufacturing cored welding electrodes or wires, in which cored electrodes are fabricated and stored in rectangular containers in a continuous or multi-step process to minimize physical damage and humidity prior to introduction into a welding process, and further to facilitate recycling of the container materials once the wire supply is exhausted.

One aspect of the invention involves techniques for manufacturing packaged cored welding electrode in a continuous or multi-step process. The process includes providing core fill material, for example, a granular or powder fill material comprising flux and alloying materials, as well as providing a strip of sheath material having laterally opposite outer edges or sides. The process further includes forming the strip into a U or V shape to provide a trough or channel between the outer edges and introducing the fill material into the channel. The outer edges are then joined by suitable metal forming dies or rollers to provide a cored electrode with the fill material enclosed within the sheath material. The cored electrode may be compacted so as to compress the inner core fill material and to set a final outer diameter for the cored electrode. The process also includes providing a generally rectangular container, such as cardboard or other suitable recyclable material and installing the cored electrode into the container. A cylindrical center core may be initially installed in the container, and an octagonal inner wall insert can be installed, with the cored electrode being wound into the gap between the container outer walls and the center core, after which a retainer structure is installed on top of the wound cored electrode coils in the container. In another aspect of the invention, the process further includes installing corner supports in corners of the container in gaps between the inner wall insert and the container, alone or in combination with installing a sealing liner in the container prior to installing the inner wall insert to provide a moisture barrier to keep the cored electrode dry. The invention thus provides a process for manufacturing and packaging cored electrode using recyclable rectangular containers by which the above mentioned shortcomings can be mitigated or overcome.

### BRIEF DESCRIPTION OF THE DRAWINGS

The following description and drawings set forth in detail certain illustrative implementations of the invention, which are indicative of several exemplary ways in which the principles of the invention maybe carried out. Various objects, advantages and novel features of the invention will become apparent from the following detailed description of the invention when considered in conjunction with the drawings, in which:

FIG. 1A is a simplified side elevation view illustrating an exemplary process for manufacturing packaged cored welding electrode in accordance with one or more aspects of the invention;

FIG. 1B is an enlarged fragmentary pictorial view further illustrating the process of FIG. 1A;

FIG. 2A is a partial end elevation view in section taken along line 2A-2A of FIG. 1B, illustrating a flat strip of sheath material used in manufacturing cored electrode;

FIG. 2B is a partial end elevation view in section taken along line 2B-2B of FIG. 1B, illustrating the sheath strip formed into a U or V shape with core fill material added to a channel of the sheath;

FIG. 2C is a partial end elevation view in section taken along line 2C-2C of FIG. 1B, illustrating the sheath strip with lateral edges thereof formed partially over the core fill material;

FIG. 2D is a partial end elevation view in section taken along line 2D-2D of FIG. 1B, illustrating the sheath strip with lateral edges thereof joined to create a cored electrode with fill material enclosed within the sheath material;

FIG. 2E is an enlarged partial end elevation view taken along line 2E-2E of FIG. 1B further illustrating the cored electrode of FIG. 2D;

FIG. 3 is a flow diagram illustrating an exemplary process or method of manufacturing packaged cored welding electrode in accordance with the present invention;

FIG. 4 is a perspective view illustrating an exemplary rectangular container employed in the processes of FIGS. 1A and 3, with a cylindrical core installed therein and cored electrode wire wound around the core and tube corner inserts;

FIG. 4A is a partial top plan view in section taken along line 4A-4A in FIG. 4, illustrating an alternative embodiment with corner reinforcing elements providing a diagonal pressure rib between the apex of the container corners and an inner liner;

FIG. 5 is a perspective view illustrating the container of FIGS. 1A, 3, and 4 with a retainer ring installed on top of the cored electrode;

FIG. 6 is a partial side elevation view in section further illustrating the container of FIGS. 1A, 3, 4, and 5 including the cylindrical core, cored electrode, and retainer; and

FIG. 7 is a perspective view illustrating a seal liner installed in the container according to another aspect of the present invention.

### DETAILED DESCRIPTION OF THE INVENTION

The invention relates to manufacturing and packaging of cored welding electrodes. One or more exemplary implementations of the present invention are hereinafter illustrated and described, wherein like reference numerals are used to refer to like elements throughout and wherein the illustrated structures are not necessarily drawn to scale.

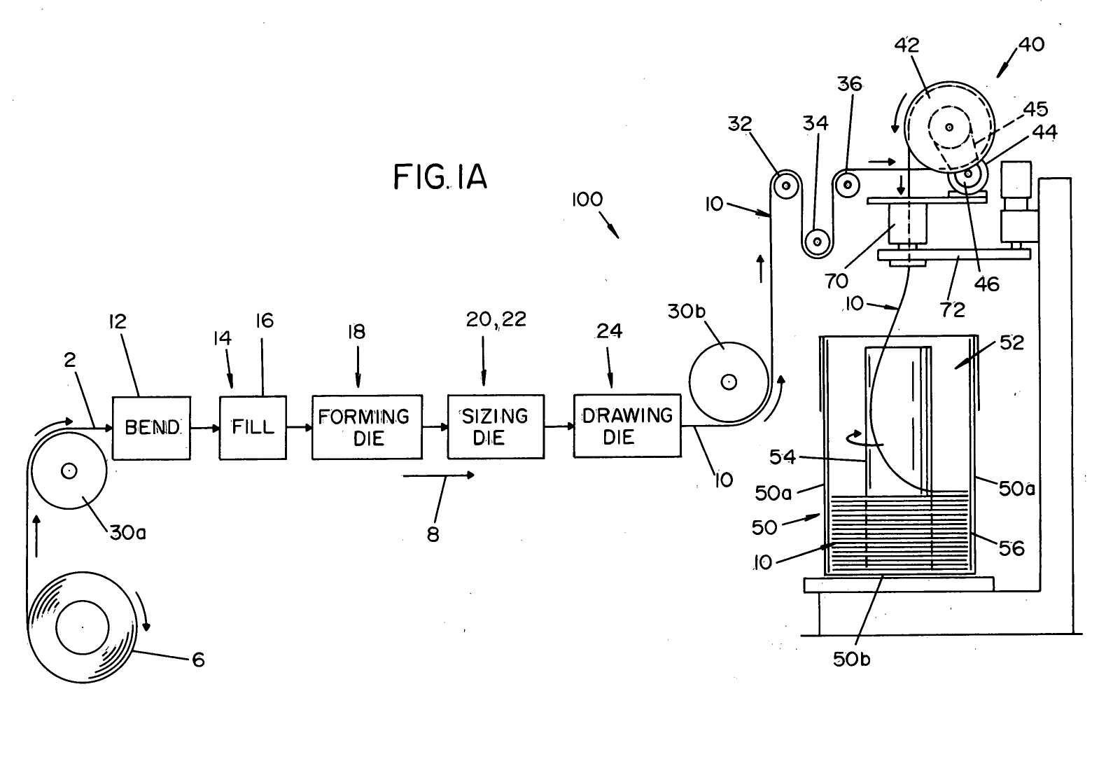

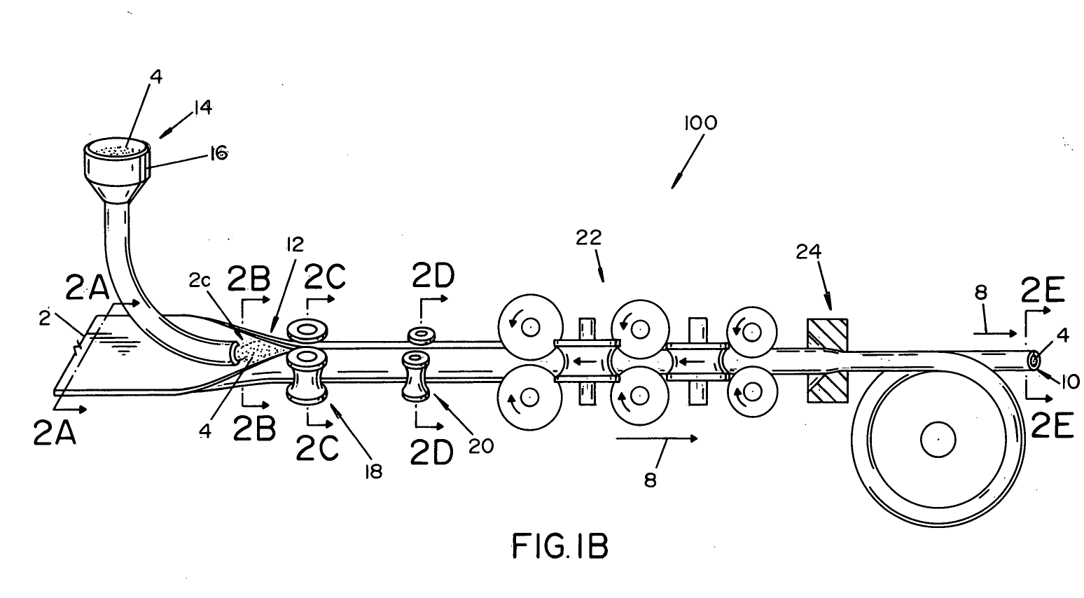

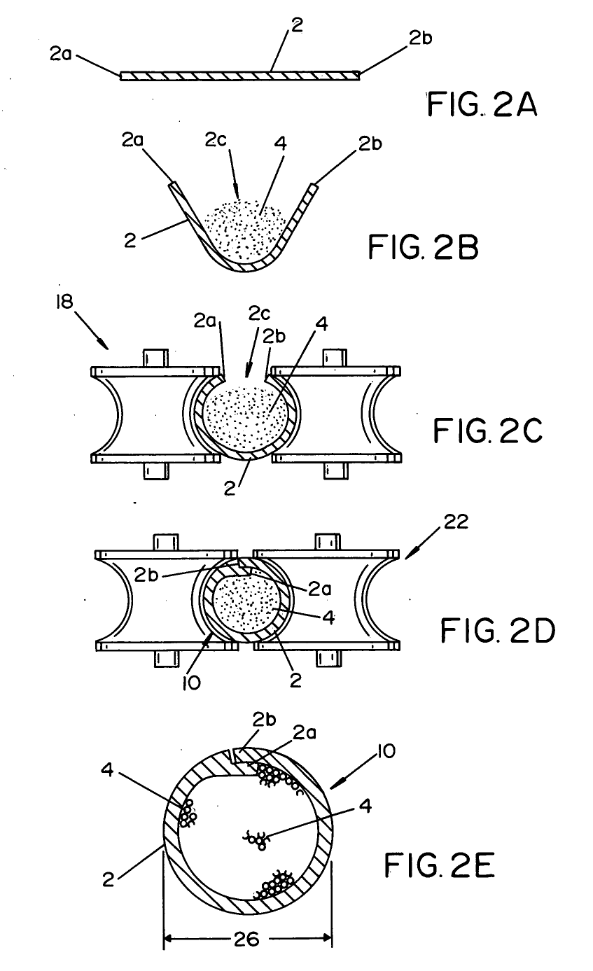

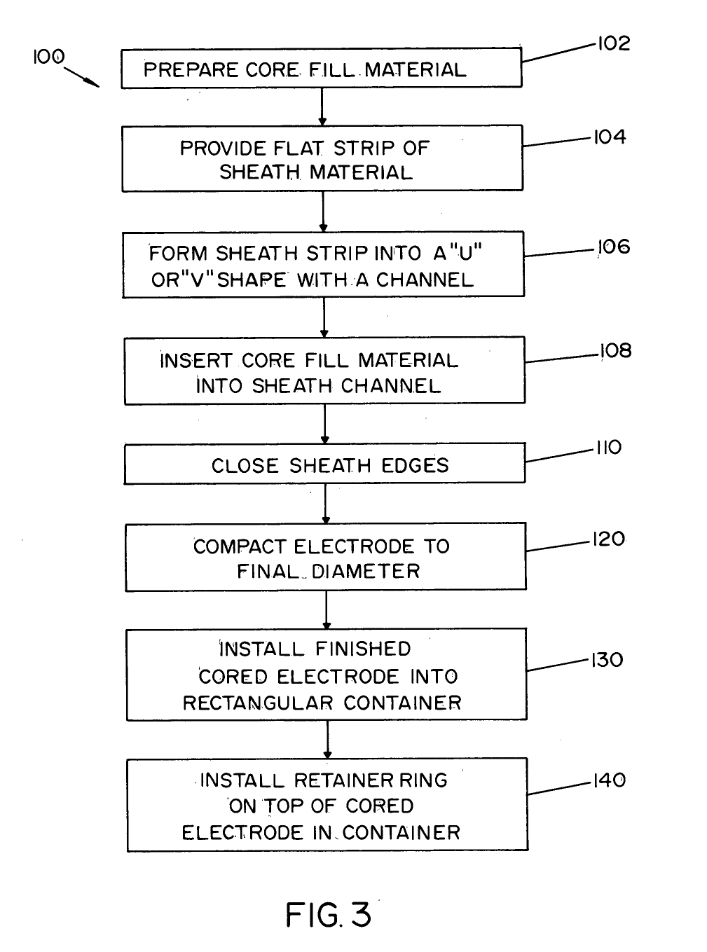

Referring to FIGS. 1A-3, FIGS. 1A and 1B illustrate an exemplary process 100 for manufacturing packaged cored welding electrode 10, FIG. 3 provides a flow diagram of the exemplary process 100, and FIGS. 2A-2E show sectional views of the manufactured cored electrode 10 at various points in the manufacturing process 100 of FIGS. 1A, 1B, and 3. In accordance with various aspects of the invention, methods are provided for manufacturing and packaging cored welding electrodes, wherein FIGS. 1A, 1B, and 3 illustrate one such method 100. Although illustrated and described herein as a series of acts or events, it will be appreciated that the exemplary process or method 100 and other processes of the invention are not limited by the illustrated ordering of such acts or events. In this regard, some acts or events may occur in different orders and/or concurrently with other acts or events apart from those illustrated and described herein, in accordance with the invention. Furthermore, it is noted that not all illustrated steps may be required to implement a process in accordance with the present invention. Moreover, the processes of the invention may be implemented in association with the illustrated structures and systems as well as with other apparatus not illustrated or described, wherein all such alternatives are contemplated as falling within the scope of the invention and the appended claims. Process 100, moreover, can be a continuous or multi-step process, beginning with a strip of substantially flat sheath material 2 being provided at a first end and ending with fabricated cored welding electrode wire 10 being packaged in rectangular containers 50 for shipment and storage, where the sheath material 2 and the electrode 10 can be continuous with the finished electrode 10 being separated from the process 100 as containers 50 are filled, at which time another container 50 is inserted while the process 100 continues. Alternatively, the electrode 10 can be wound onto storage reels or spools at one or more intermediate stages in the process 100.

As shown in FIGS. 1A and 3, the process 100 includes preparation or provision of core fill material 4 at 102 (FIG. 3) as well as provision of a flat strip 2 of sheath material at 104. In an exemplary implementation of process 100, sheath material 2 is mild steel, with core fill material 4 including fluxing and alloying materials. The electrode materials 2, 4 in general are designed for deoxidizing, slag formation, arc stabilization, alloying, and/or to provide shielding gas for the target welding process, where the sheath or steel portion 2 preferably comprises about 75 to 90 percent of the electrode by weight, with the core material 4 providing the remaining 10 to 25 percent. In other possible implementations of the invention, sheath material 2 may be any suitable ferrous or non-ferrous metal, alloy composition, or a bimetallic structure comprising two or more different alloys. In general, sheath strip 2 can be made of any suitable sheath material for use in metal or flux-cored welding electrodes, such as steel, where the material employed in a given electrode manufacturing process may be selected according to the type of welding process in which the packaged electrode will be employed.

Core material 4 may include any type of solid and/or liquid material that operates to provide desired welding conditions and/or materials during use in a GMAW-C or FCAW process. For example, material 4 may include granules of one or more materials to provide welding flux in a welding operation, to control or inhibit oxidation and/or nitridation in the finished weld metal, alone or in combination with alloying materials to control the material content of the finished weld metal (e.g., elements to increase weld joint strength and/or toughness and/or to enhance corrosion resistance), and/or arc stabilizing materials. The selection of core fill material constituents preferably accounts for whether the cored-electrode is intended for self-shielding or gas shielded welding processes. In this regard, core fill material 4 for self-shielding type flux-cored electrode 10 wires preferably includes additional gas forming elements to inhibit ambient oxygen and/or nitrogen contacting metal being transferred across a welding arc and/or deposited metal of the molten weld puddle or pool on the workpiece. The core fill material is preferably in powder form, including one or more powders typically used in cored electrodes as alloying agents, fluxing agents, slag formers, arc stabilizers, deoxidizers, desulfurizers, denitriders, dephosphorizers, or other constituents to achieve one or more desired operating characteristics during welding, such as reducing spatter, improving weld bead appearance, etc. Examples of suitable arc stabilizers include but are not limited to graphite, sodium titanate, potassium titanate, and feldspars, and some useful slag forming and gas forming materials include titanium dioxide, silicon dioxide, magnesium oxide, aluminum oxides, carbonates, fluorides, and the like. Core material 4 may include alloying agents, such as chromium, aluminum, titanium, boron, iron, copper, cobalt, manganese, vanadium, nickel, molybdenum, niobium, tungsten, and/or alloys thereof, and some suitable deoxidizing, desulfurizing, and/or denitriding materials may be used, for example, calcium, titanium, barium, magnesium, aluminum, silicon, zirconium, rare earths metals, and/or alloys thereof.

In the initial flat strip form, sheath 2 includes two generally parallel laterally opposite outer edges 2a and 2b (FIG. 2A), with sheath strip material 2 being provided from a roll 6 (FIG. 1A) or other supply and idler roll 30a in a continuous form. At 106 in FIG. 3, strip 2 is formed (e.g., bent) into a “U” or “V” shape, thereby providing a channel 2c between outer edges 2a and 2b, as best shown in FIG. 2B. Throughout process 100, sheath material 2 is supported along various guiding and support apparatus (not shown) and translated along an axial direction indicated by arrow 8 in FIGS. 1A and 1B, where suitable forming rollers and/or dies 12 are employed to bend sheath strip 2 into the V or U shape at 106, thereby providing channel 2c. Fill material 4 is then introduced at 108 or added into channel 2c (FIG. 2B), for example, using a granule feeding apparatus 14 (FIGS. 1A and 1B) configured to supply core fill material 4 from a fill supply 16 to channel 2c at a volume transfer rate determined according to the speed at which strip 2 is translated in direction 8 and according to the desired final dimensions of finished cored electrode 10. The continuous process 100 continues at 110 in FIG. 3 with lateral strip edges 2a ands 2b being closed by procession of strip 2 through a series of forming rolls 18, 20, and 22, as best illustrated in FIGS. 1B, 2C, and 2D. Any forming and shaping tooling, dies, forming rolls, etc. may be employed at 110 to join edges 2a and 2b by which a cored electrode structure 10 is provided with core fill material 4 being enclosed within sheath material 2 (FIGS. 2D and 2E), wherein edges 2a and 2b may abut one another or may be folded over one another as in the exemplary electrode 10 of FIGS. 2D and 2E. At this point, core fill material may remain somewhat loosely packed, in which case cored electrode structure 10 may be compacted at 120, for example, using a sizing die 24 (FIGS. 1A and 1B) in a reduction drawing process to set a desired final electrode outer diameter 26 (FIG. 2E) and also to compress core fill material 4. The outer diameter adjustment at 120 advantageously ensures or facilitates compatibility between the cored electrode 10 and a wire feeder (not shown) employed in the target welding process, and the compaction of fill material 4 ensures the appropriate proportions of sheath steel material 2 and fill material 4 to achieve the desired weld properties. Other suitable processing steps may also be performed, for example, cleaning of the closed sheath material 2, annealing, further drawing operations, and/or coating steps (not shown) to yield the finished cored electrode 10 of FIGS. 1A, 1B, and 2E. Preferably, the drawn sheath 2 and the process 100 provides essentially complete and uniform compaction of fill material 4 without separation of the fill mixture, as well as a seam joint of sheath edges 2a and 2b that does not separate during process 100, or in storage within container 50, or in operational use when fed through a wire feeder to a welding process (not shown). In this regard, the integrity of the seam or joinder of edges 2a and 2b may impact welding performance of electrode 10 with respect to preventing loss of material 4 from the core and/or inhibiting moisture penetration through sheath 2 into core fill material 4. In addition, uniformity of the seam joint and the final outer diameter 26, as well as uniformity of core compaction and uniformity of any applied outer coating may affect feedability and/or electrical properties of electrode 10 in use, wherein process 100 may be designed with these considerations in mind so as to avoid or mitigate feeding problems, sporadic arc engagement problems, discontinuities in the applied coating, moisture to penetration of the core material 4.

Referring now to FIGS. 1A, 1B, and 3-7, process 100 continues at 130 in FIG. 3 with finished electrode 10 being installed (e.g., coiled or wound) into a rectangular container 50 provided at the end of continuous process 100, as best shown in FIG. 1A. In the illustrated implementation, cored electrode wire 10 is provided from final sizing die 24 to a series of roller guides 30b, 32, 34, and 36 to a winding apparatus 40 for installation into container 50. In the past, cored welding electrodes were typically wound onto a spool that could then be rotatably mounted near the wire feeding apparatus of a welding system, or the wire was sometimes wound into cylindrical drums for shipment and storage prior to use. However, as mentioned above, high volume robotic welding systems require a large continuous supply of welding electrode to minimize system downtime. Furthermore, cylindrical containers are not well suited for transportation and/or storage. In order to overcome these shortcomings of conventional cored electrode packages, the present invention provides for packaging of the fabricated cored electrode 10 by providing a generally rectangular container 50 in the continuous process 100, with the container 50 being largely fabricated from cardboard or other environmentally friendly material that can be easily recycled after the supply of electrode 100 therein is exhausted. Any suitable winding apparatus and winding patterns or techniques may be employed to install electrode 10 into rectangular container 50 within the scope of the invention. Some examples of suitable winding techniques and apparatus are set forth in Cooper U.S. Pat. No. 6,019,303 and Cooper U.S. Pat. No. 6,260,781, incorporated herein by reference, in which wire is deposited in layers, with each layer having a plurality of loops of a specified diameter circumferentially and eccentrically positioned about an interior cavity 52 of container 50, wherein adjacent layers have different loop diameters and circumferential positions to produce a dense packing of wire 10 with a uniform radial density (not shown). In the illustrated process 100 shown in FIG. 1A, winding apparatus 40 draws a continuous welding wire 10 from the above described manufacturing portion of continuous process 100 via a capstan 42 driven by a wire feed motor 44 connected to a pulley 46 which drives a belt 45 for rotating capstan 42 in the indicated direction with dancer rolls 32, 34, and 36 maintaining generally consistent electrode tension between roller guide 30b and capstan 42. In this configuration, electrode 10 is wrapped about 270 degrees about capstan 42, thereby providing a measure of friction and drive capacity to draw wire 10 across rolls 32-36. From capstan 42, cored welding electrode 10 is fed into a hollow movable laying head 70 supported on a winding beam 72 which is translated in two dimensions to achieve a circular winding pattern to install electrode 10 from capstan 42 through laying head 70 and into interior 52 of container 50 to form a generally cylindrical winding stack 10 around center core 54 of container 50.

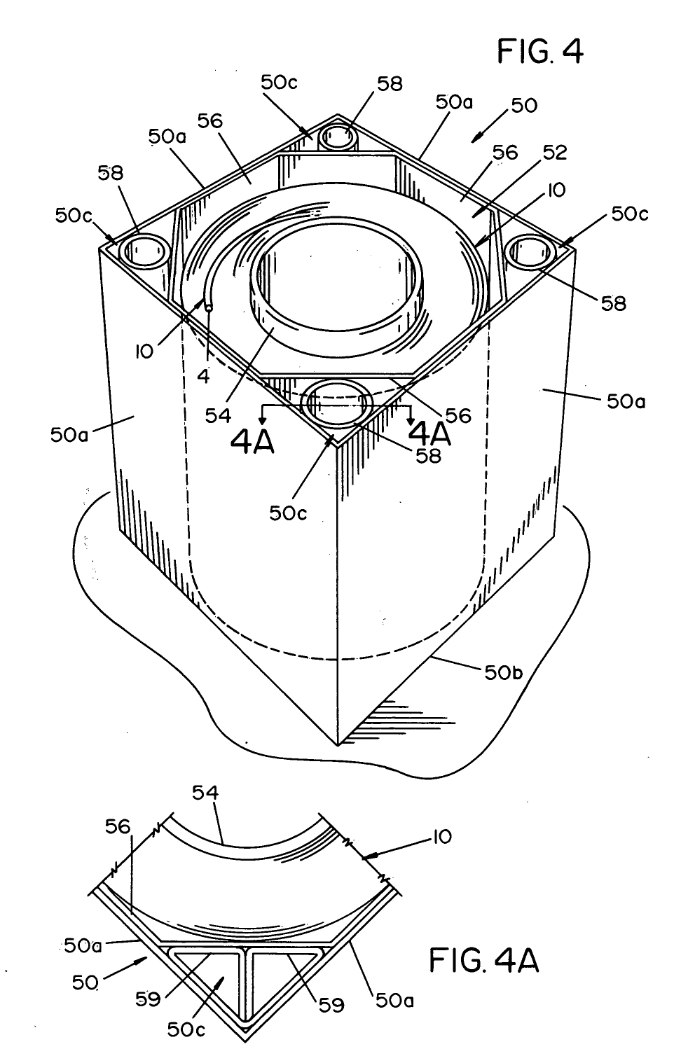

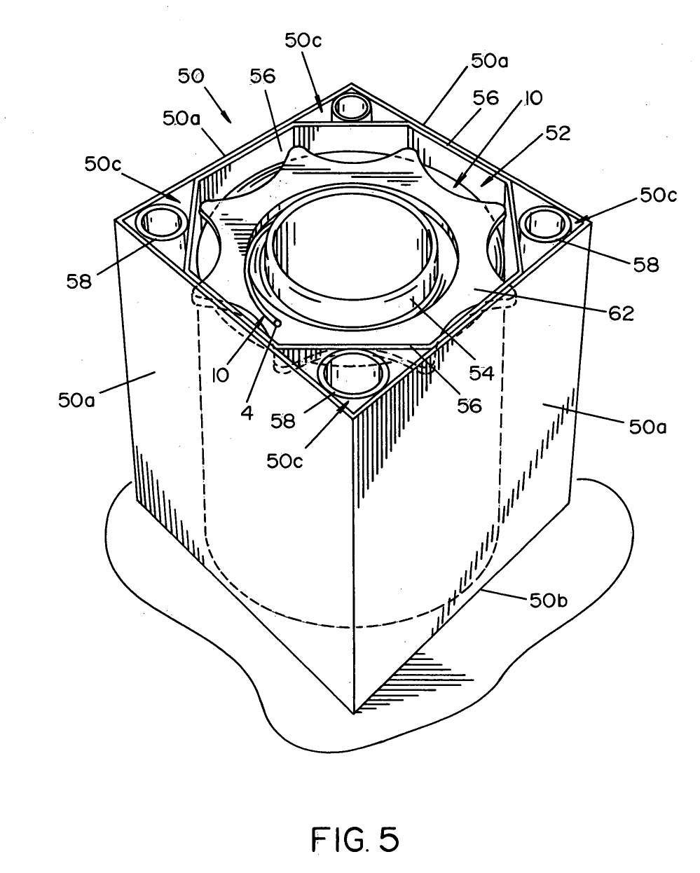

In the illustrated process 100, generally rectangular container 50 is provided in the form of a generally rectangular cardboard box 50 (FIGS. 1A and 4-7) having four vertical walls 50a, a bottom 50b, and four vertically extending corners 50c, each defining an apex, as best illustrated in FIGS. 4-7. In this implementation, a cylindrical center core 54 is installed in container 50 prior to installation of cored electrode 10 therein, with electrode 10 being wound in an interior gap between walls 50a and center core 54. In another aspect of the invention, the container 50 is provided with a generally octagonal inner wall insert 56 in the generally rectangular container 50 prior to installing cored electrode 10. Any form and shape of insert 56 may be employed within the scope of the invention. In the case of an octagonal inset 56, one or more corner supports, such as vertically extending tubes 58 may be installed in container corners 50c between walls 50a and insert 56. FIG. 4A shows one possible alternate implementation in which corner reinforcing elements 59 are employed in the container corners 50c, which may be fashioned by folding cardboard or other suitable material into a dual triangle form as shown in FIG. 4A, or may be fashioned from two separate triangular structures. As shown in FIG. 4A, the use of the dual triangular shaped corner reinforcing elements 59 provides a diagonal pressure rib between the apex of the container corners 50c and the inner liner 56 of the container 50, wherein suitable dual triangular shaped corner reinforcing elements are illustrated and described in Barton U.S. Pat. No. 6,564,943, incorporated herein by reference.

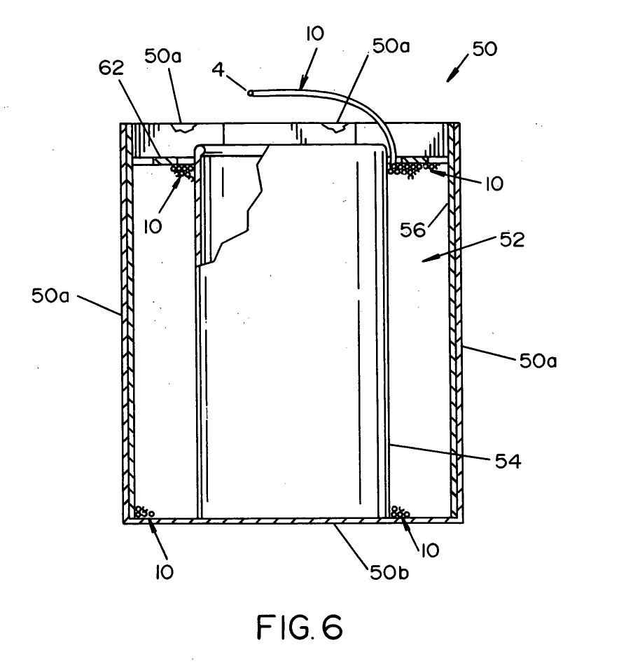

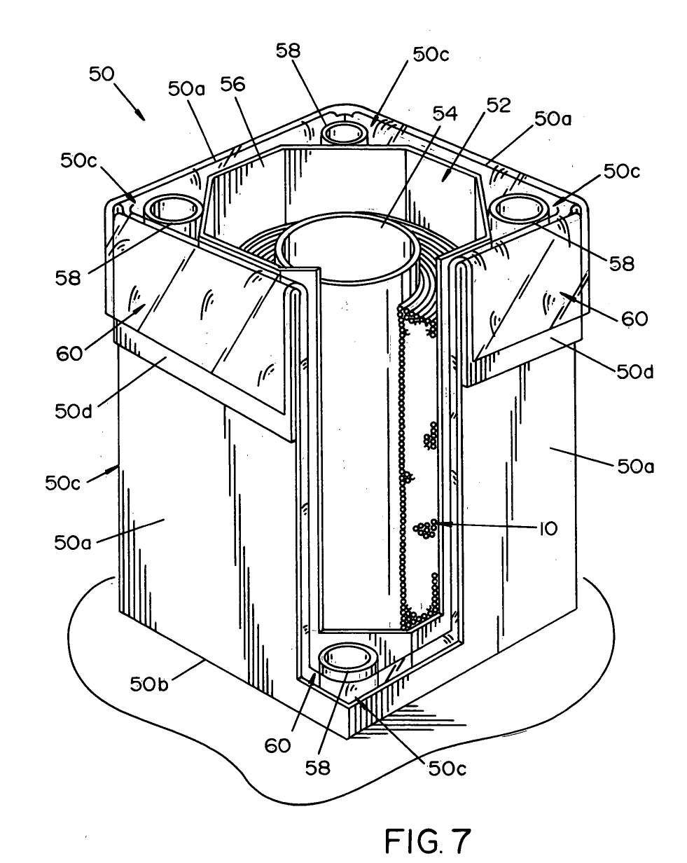

In addition, as shown in FIG. 7, a sealing liner or bag 60 may be installed in container 50 prior to installing inner wall insert 56 to provide a moisture barrier for protecting the wound wire coils 10 from adverse effects of humidity during transportation and storage. As noted above, exposure of the cored electrode 10 to high humidity can lead to undesirable porosity in the weld bead due to core moisture, and excessive moisture also can create rust on the electrode sheath material 2. A coil of cored welding electrode wire 10 is wound by apparatus 40 around center core 54, with the octagonal insert 56 and corner support tubes 58 operating to evenly distribute the and outwardly directed forces from the coiled wire 10 to mitigate deformation of outer walls 50a of container 50, wherein wire 10 is situated as a hollow generally cylindrical store of cored electrode 10 between insert 56 and core 54. This exemplary container configuration facilitates coiling or winding of electrode 10 around center core 54 so as to essentially fill the space between core 54 and insert 56, where wire 10 preferably engages eight different surfaces to restrict the outer diameter of electrode coils 10 and to thereby inhibit outward spreading of coils 10 during coiling, shipping, storage, and unwinding during a welding operation. Moreover, the use of octagonal insert 56 provides four triangular cavities at corners 50c, in which vertical reinforcing tubes 58 or other shaped structures can be installed in order to increase vertical rigidity of container 50 and thereby facilitate stacking of filled containers 50, as well as inhibiting deformation of outer walls 50a near corners 50c. Furthermore, the exemplary bottom 50b, walls 50a, corner supports 58, octagonal inner wall insert 56, and cylindrical inner core 54 are preferably made of cardboard or other suitable recyclable material. Accordingly, once container 50 has been emptied at a welding site, all container components can be recycled as used cardboard. As individual containers 50 are filled to capacity in the manufacturing process 100 with coils of cored electrode 10, electrode 10 is separated and another container 50 is provided to receive the electrode from winding apparatus 40. A retainer structure (FIGS. 5 and 6), such as a ring 62 or other shaped retaining device, can be installed at 140 in FIG. 3 on top of the uppermost coils of cored electrode 10 in the filled container 50 and the container 50 may be closed with a separate lid or by flaps 50d as shown in FIG. 7, with the optional sealing liner 60 being folded over electrode coils 10 and sealed with a wire tie (not shown).

The invention has been illustrated and described with respect to one or more exemplary implementations or embodiments. However, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

Having thus described the invention, the following is claimed:

1. A process for manufacturing packaged cored welding electrode, said process comprising:
providing core fill material;
providing a strip of sheath material having laterally opposite outer edges;
forming said strip into a U or V shape to provide a channel between said outer edges;
adding said fill material into said channel;
joining said outer edges to provide a cored electrode-with said fill material enclosed within said sheath material;
providing a generally rectangular container; and
installing said cored electrode into said container.

2. A process as defined in claim 1, further comprising compacting said cored electrode prior to installing said cored electrode into said container.

3. A process as defined in claim 2, wherein said container is cardboard.

4. A process as defined in claim 1, wherein said container is cardboard.

5. A process as defined in claim 4, further comprising installing a cylindrical center core in said container prior to installing said cored electrode into said container.

6. A process as defined in claim 3, further comprising installing a cylindrical center core in said container prior to installing said cored electrode into said container.

7. A process as defined in claim 2, further comprising installing a cylindrical center core in said container prior to installing said cored electrode into said container.

8. A process as defined in claim 1, further comprising installing a cylindrical center core in said container prior to installing said cored electrode into said container.

9. A process as defined in claim 8, further comprising installing a retainer on top of said cored electrode in said container.

10. A process as defined in claim 7, further comprising installing a retainer on top of said cored electrode in said container.

11. A process as defined in claim 6, further comprising installing a retainer on top of said cored electrode in said container.

12. A process as defined in claim 5, further comprising installing a retainer on top of said cored electrode in said container.

13. A process as defined in claim 4, further comprising installing a retainer on top of said cored electrode in said container.

14. A process as defined in claim 3, further comprising installing a retainer on top of said cored electrode in said container.

15. A process as defined in claim 2, further comprising installing a retainer on top of said cored electrode in said container.

16. A process as defined in claim 1, further comprising installing a retainer on top of said cored electrode in said container.

17. A process as defined in claim 16, wherein providing said core fill material comprises preparing a granular or powder fill material including flux materials and alloying materials.

18. A process as defined in claim 8, wherein providing said core fill material comprises preparing a granular or powder fill material including flux materials and alloying materials.

19. A process as defined in claim 4, wherein providing said core fill material comprises preparing a granular or powder fill material including flux materials and alloying materials.

20. A process as defined in claim 2, wherein providing said core fill material comprises preparing a granular or powder fill material including flux materials and alloying materials.

21. A process as defined in claim 1, wherein providing said core fill material comprises preparing a granular or powder fill material including flux materials and alloying materials.

22. A process as defined in claim 1, further comprising installing an inner wall insert in said generally rectangular container prior to installing said cored electrode in said container.

23. A process as defined in claim 22, further comprising installing a sealing liner in said container prior to installing said inner wall insert.

24. A process as defined in claim 22, wherein said inner wall insert is generally octagonal.

25. A process as defined in claim 24, further comprising installing corner supports in corners of said container in gaps between said inner wall insert and said container.
